(19) United States
(12) Patent Application Publication
(10) Pub. No.: US 2008/0197606 A1
(43) Pub. Date: Aug. 21, 2008

(54) Trailer hitch for automatically allowing a trailer to tilt for facilitating driving a vehicle on and off the trailer

(76) Inventor: Daniel A. Capuano, Lake Grove, NY (US)

Correspondence Address: RICHARD L. MILLER, 12 PARKSIDE DRIVE, DIX HILLS, NY, 11746, US

(21) Appl. No.: 11/708,112

(22) Filed: Feb. 16, 2007

(51) Int. Cl. B60D 1/36

(52) U.S. Cl. 280/477

(57) ABSTRACT

A trailer hitch for automatically allowing a trailer to tilt for facilitating driving a vehicle on and off the trailer which comprises a hitch coupler having forward and rearward ends. The forward end of the hitch coupler is adapted for removable connection to a receiver hitch of a towing truck. A vertically oriented main support assembly is connected to the rearward end of the hitch coupler. A sliding mechanism is carried on the main support assembly, wherein the sliding mechanism can freely travel between a lower position and an upper position on the main support assembly. A hitching mechanism is attached to the sliding mechanism. The hitching mechanism is suited for coupling the trailer to the towing truck. When the vehicle is driven off the trailer onto a ramp of the trailer, the weight of the vehicle on the ramp will make wheels of the trailer act as a fulcrum, causing the trailer to tilt and the hitching mechanism to lift up the sliding mechanism from the lower position to the upper position on the main support assembly. In a second embodiment the trailer hitch is provisioned to accommodate for the installation on towing trucks of various heights.

### BACKGROUND OF THE INVENTION

1. Field of the Invention

The present invention relates to a trailer hitch, and more particularly, a trailer hitch for automatically allowing a trailer to tilt for facilitating driving a vehicle on and off the trailer.

2. Description of the Prior Art

Numerous innovations for hitch assemblies have been provided in the prior art that will be described. Even though these innovations may be suitable for the specific individual purposes to which they address, however, they differ from the present invention.

A FIRST EXAMPLE, U.S. Pat. Office Document No. 3,554,578, Issued on Jan. 12, 1971, to Reed teaches two elements of a trailer hitch that are connected respectively to the forward end of a trailer and to the rear end of a truck or other towing vehicle, the latter element being vertically movable by power to effect the tilting of the trailer when desired.

A SECOND EXAMPLE, U.S. Pat. Office Document No. 4,564,209, Issued on Jan. 14, 1986, to Kingsley et al. teaches a hitch assembly that includes a frame which is fixedly attached to the rear of a truck and extends widthwise of the truck to provide upper and lower horizontal rails. A transverse carriage having upper and lower roller assemblies engageable with the rails is mounted to the frame and moved laterally relative to the frame by means of a ram assembly. The ram assembly includes a piston extending from end-to-end of the frame and a cylinder which is fixedly attached to the carriage and movably mounted to the piston. A vertical lift carriage is slidably mounted to the transverse carriage and is movable vertically relative to the frame by a ram assembly. The vertical carriage includes a hitch ball for attachment of a trailer tow bar and the transverse and vertical carriages provide the hitch connection and the tow bar with vertical and laterally horizontal components of movement. A support is provided for the vertical carriage so that when desired the rear of the truck can be raised and moved both transversely and vertically relative to the hitch connection while the trailer is stationary to provide additional movement.

A THIRD EXAMPLE, U.S. Pat. Office Document No. 6,155,588, Issued on Dec. 05, 2000, to Maxey teaches a tilting trailer hitch that includes a compressible main support assembly having a hitch coupler and a hitching mechanism attached thereto. The hitch coupler is configured to connect a towing connector to a towing vehicle and the hitching mechanism is configured to couple with a trailer. An actuator is pivotally connected to the main support assembly in response to trailer loading and is operable to rotate part of the main support assembly, thereby raising or lowering the hitching mechanism along a generally arcuate path. When the hitching mechanism is in the raised position, a loading end of the trailer is lowered to assist in loading the trailer.

A FOURTH EXAMPLE, U.S. Pat. Office Document No. 6,585,280 B1, Issued on Jul. 01, 2003, to Wiers teaches an adjustable hitch assembly that is mounted on a towing vehicle and is adapted to move the hitch transversely, horizontally and vertically with respect to the towing vehicle. A first traveler is provided in a horizontally disposed C-shaped channel and is selectively movable along the channel with a rotataly driven threaded rod. A vertical C-shaped channel is mounted to the first traveler. A second traveler is provided in the vertical channel and is selectively movable along the vertical channel with a threaded rod extending longitudinally in the vertical channel. A hitch is mounted to the vertical channel traveler and is adapted for connecting to a trailer.

A FIFTH EXAMPLE, U.S. Pat. Office Document No. 6,726,237 B1, Issued on Apr. 27, 2004, to Carrico teaches a vertically operable hitch that includes a horizontal support member with the forward end journaled in the receiver of a tow vehicle. An upright post on the support member has a carrier operably mounted thereon for selective vertical movement along the post. A hitch ball is mounted on the carrier for selective connection to the tongue of a towed trailer to thereby selectively raise and lower the hitch ball.

A SIXTH EXAMPLE, U.S. Pat. Office Document No. 6,824,156 B2, Issued on Nov. 30, 2004, to Smith teaches a hitch assembly adapted to secure a trailer and tractor vehicle that includes an elongated housing, a threaded shaft in the housing, a coupling member on the shaft, a carriage member secured to the coupling member, a rotatable drive that turns the shaft to advance the coupling member and carriage member, a first member secured to the housing for connection to one of the vehicles and a second member secured to the carriage for connection to the other vehicle. This allows the effective height of the hitch assembly to be varied so that different towing situations can be accommodated. In one embodiment, flat slide surfaces between the carriage and the housing are provided. A yoke assembly is also disclosed.

It is apparent now that numerous innovations for hitch assemblies have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a trailer hitch for automatically allowing a trailer to tilt for facilitating driving a vehicle on and off the trailer that avoids the disadvantages of the prior art.

ANOTHER OBJECT of the present invention is to provide a trailer hitch for automatically allowing a trailer to tilt for facilitating driving a vehicle on and off the trailer that is simple and inexpensive to manufacture.

STILL ANOTHER OBJECT of the present invention is to provide a trailer hitch for automatically allowing a trailer to tilt for facilitating driving a vehicle on and off the trailer that is simple to use.

BRIEFLY STATED, STILL YET ANOTHER OBJECT of the present invention is to provide a trailer hitch for automatically allowing a trailer to tilt for facilitating driving a vehicle on and off the trailer which comprises a hitch coupler having forward and rearward ends. The forward end of the hitch coupler is adapted for removable connection to a receiver hitch of a towing truck. A vertically oriented main support assembly is connected to the rearward end of the hitch coupler. A sliding mechanism is carried on the main support assembly, wherein the sliding mechanism can freely travel between a lower position and an upper position on the main support assembly. A hitching mechanism is attached to the sliding mechanism. The hitching mechanism is suited for coupling the trailer to the towing truck. When the vehicle is driven off the trailer onto a ramp of the trailer, the weight of the vehicle on the ramp will make wheels of the trailer act as a fulcrum, causing the trailer to tilt and the hitching mechanism to lift up the sliding mechanism from the lower position to the upper position on the main support assembly.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view illustrating a first embodiment of the present invention being installed on a towing truck;

FIG. 2 is an enlarged diagrammatic side elevational view, partially in section, of the hitch per se, with parts broken away, taken in the direction of arrow 2 in FIG. 1;

FIG. 3 is a diagrammatic side elevational view showing the first embodiment of the present invention in use, hitching the towing truck to a trailer with a vehicle on the trailer;

FIG. 4 is an enlarged diagrammatic side elevational view of the area enclosed in the dotted circle indicated by arrow 4 in FIG. 3, showing the position of the hitch sliding mechanism with the trailer level and ready for towing;

FIG. 5 is a diagrammatic side elevational view showing the first embodiment of the invention in use, hitching the towing truck to the trailer with the vehicle being unloaded from the trailer;

FIG. 6 is an enlarged diagrammatic side elevational view of the area enclosed in the dotted circle indicated by arrow 6 in

FIG. 5, showing how the hitch sliding mechanism operates to permit the trailer to tip automatically when the vehicle is driven off the trailer; and

FIG. 7 is an enlarged diagrammatic side elevational view, partially in section, showing a second embodiment of the invention provisioned to accommodate for the installation on towing trucks of various heights.

### A MARSHALLING OF REFERENCE NUMERALS UTILIZED IN THE DRAWING

### First Embodiment

10 trailer hitch
12 trailer
14 vehicle
16 hitch coupler of trailer hitch 10
18 forward end of hitch coupler 16
20 rearward end of hitch coupler 16
22 receiver hitch
24 towing truck
26 main support assembly of trailer hitch 10
28 sliding mechanism of trailer hitch 10
30 hitching mechanism of trailer hitch 10
32 ramp of trailer 12
34 wheel of trailer 12
36 draw bar of hitch coupler 16
38 hitch pin of hitch coupler 16
40 cotter pin of hitch coupler 16
42 C-shaped member of main support assembly 26
44 top stop portion of C-shaped member 42
46 vertical elongated side portion of C-shaped member 42
48 bottom stop portion of C-shaped member 42
50 upper brace of main support assembly 26
52 lower brace of main support assembly 26
54 base plate of main support assembly 26
56 vertical square shaped guide bar of main support assembly 26
58 square shaped collar of sliding mechanism 28
60 mounting plate of hitching mechanism 28
62 hitch bracket of hitching mechanism 30
64 hitch ball of hitching mechanism 30
66 socket member
68 towing end of trailer 12
70 retainer latch of hitching mechanism 30
72 locking mechanism of trailer hitch 10
74 transverse aperture in square shaped guide bar 56
76 aperture in square shaped collar 58
78 locking pin of locking mechanism 72
80 cotter pin of locking mechanism 72

### Second Embodiment

110 trailer hitch
126 main support assembly of trailer hitch 110
142 C-shaped member of main support assembly 126
144 top stop portion of C-shaped member 142
146 vertical elonogated side portion of C-shaped member 142
148 bottom stop portion of C-shaped member 142
150 upper brace of main support assembly 126
152 lower brace of main support assembly 126
154 base plate of main support assembly 126
156 vertical square shaped guide bar of main support assembly 126
182 sleeve member of main support assembly 126
184 forward end of sleeve member 182
186 fastener

### DETAILED DESCRIPTION OF THE PREFERRED EMBODIMENT

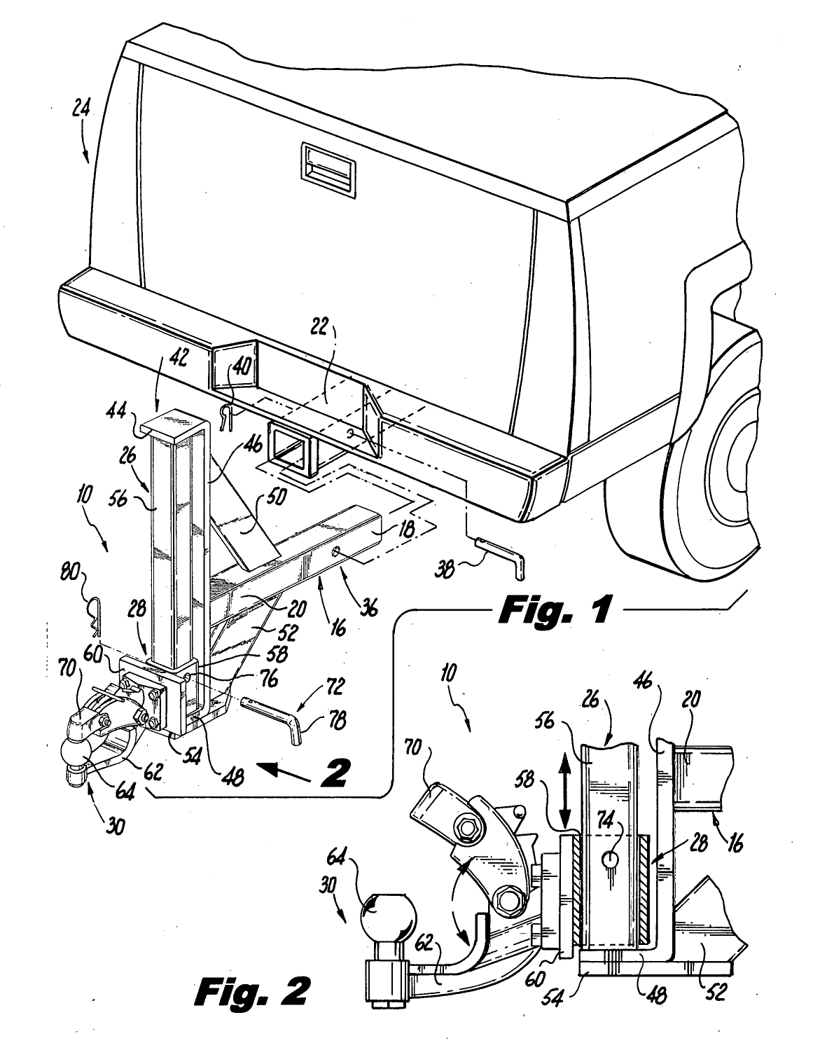

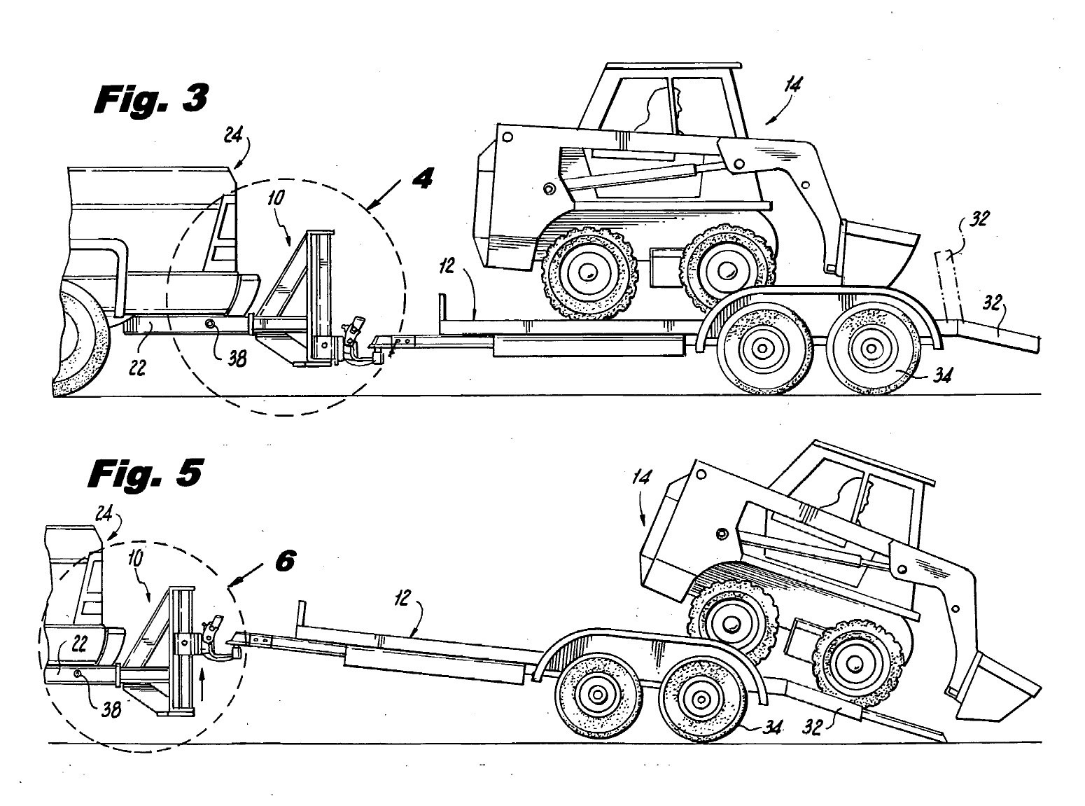

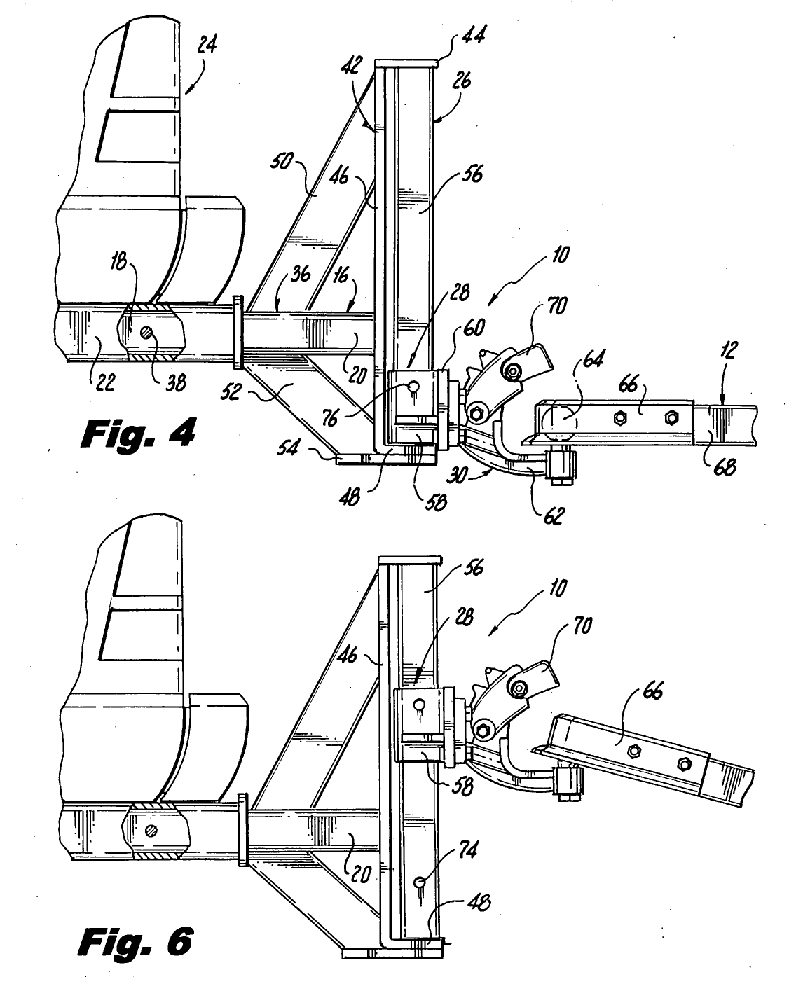

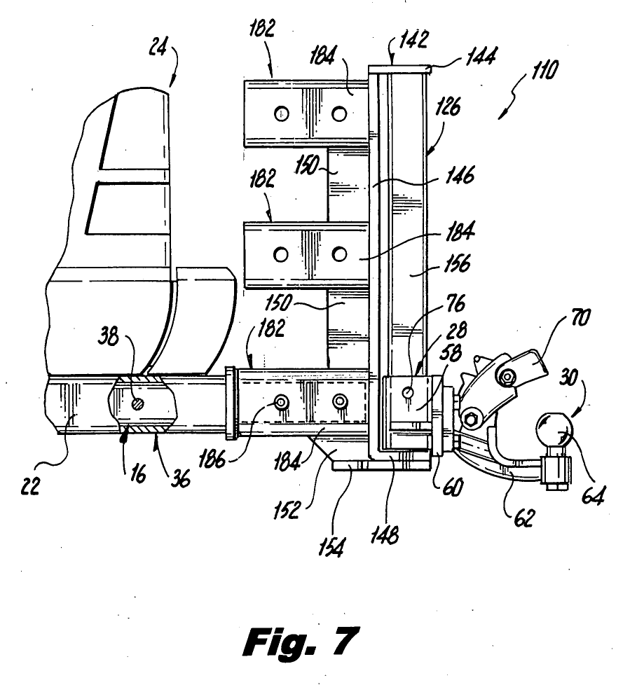

Referring now to the figures, in which like numerals indicate like parts, and particularly to FIGS. 1 through 6, which are a diagrammatic perspective view illustrating a first embodiment of the present invention being installed on a towing truck; an enlarged diagrammatic side elevational view, partially in section, of the hitch per se, with parts broken away, taken in the direction of arrow 2 in FIG. 1; a diagrammatic side elevational view showing the first embodiment of the present invention in use, hitching the towing truck to a trailer with a vehicle on the trailer; an enlarge diagrammatic side elevational view of the area enclosed in the dotted circle indicated by arrow 4 in FIG. 3, showing the position of the hitch sliding mechanism with the trailer level and ready for towing; a diagrammatic side elevational view showing the first embodiment of the invention in use, hitching the towing truck to the trailer with the vehicle being unloaded from the trailer; and an enlarged diagrammatic side elevational view of the area enclosed in the dotted circle indicated by arrow 6 in FIG. 5, showing how the hitch sliding mechanism operates to permit the trailer to tip automatically when the vehicle is driven off the trailer, and as such, will be discussed with reference thereto.

The present invention is a trailer hitch 10 for automatically allowing a trailer 12 to tilt for facilitating driving a vehicle 14 on and off the trailer 12 which comprises a hitch coupler 16 having forward end rearward ends 18, 20. The forward end 18 of the hitch coupler 16 is adapted for removable connection to a receiver hitch 22 of a towing truck 24. A vertically oriented main support assembly 26 is connected to the rearward end 20 of the hitch coupler 16. A sliding mechanism 28 is carried on the main support assembly 26, wherein the sliding mechanism 28 can freely travel between a lower position and an upper position on the main support assembly 26. A hitching mechanism 30 is attached to the sliding mechanism 28. The hitching mechanism 30 is suited for coupling the trailer 12 to the towing truck 24. When the vehicle 14 is driven off the trailer 12 onto a ramp 32 of the trailer 12, the weight of the vehicle 14 on the ramp 32 will make wheels 34 of the trailer 12 act as a fulcrum, causing the trailer 12 to tilt and the hitching mechanism 30 to lift up the sliding mechanism 28 from the lower position to the upper position on the main support assembly 26.

The hitch coupler 16 comprises a draw bar 36 sized to fit into the receiver hitch 22. A hitch pin 38 is for holding the draw bar 22 within the receiver hitch 22. A cotter pin 40 is releasably secured to the hitch pin 38.

The main support assembly 26 comprises a C-shaped member 42 having a top stop portion 44, a vertical elongated side portion 46 and a bottom stop portion 48. An upper brace 50 extends between the draw bar 36 of the hitch coupler 16 and the top stop portion 44 of the C-shaped member 42. A lower brace 52 extends between the draw bar 36 of the hitch coupler 16 and the bottom stop portion 48 of the C-shaped member 42. A base plate 54 is affixed to underside of the bottom stop portion 48 of the C-shaped member 42 and the lower brace 52. A vertical square shaped guide bar 56 is mounted between the top stop portion 44 and the bottom stop portion 48 and is spaced away from the vertical elongated side portion 46 of the C-shaped member 42. The sliding mechanism 28 comprises a square shaped collar 58 sized to freely slide on the vertical square shaped guide bar 56 of the main support assembly 26.

The hitching mechanism 30 comprises a mounting plate 60 connected to a forward side of the square shaped collar 58 of the sliding mechanism 28. A hitch bracket 62 is bolted onto the mounting plate 60. A hitch ball 64 is carried on a forward end of the hitch bracket 62 which engages with a socket member 66 on a towing end 68 of the trailer 12. The hitching mechanism 30 further comprises a retainer latch 70 to help hold the socket member 66 on the towing end 68 of the trailer 12 onto the hitch ball 64, if the retainer latch 70 is flipped downwardly.

The trailer hitch 10 further comprises a mechanism 72 for locking the square shaped collar 58 to a lower end of the vertical square shaped guide bar 56 to keep the trailer 12 in a generally horizontal position when being towed by the towing truck 24. The locking mechanism 72 comprises the square shaped guide bar 56 having a transverse aperture 74 near the lower end. The square shaped collar 58 has a pair of aligned apertures 76 with each aperture 76 located on an opposite side thereof. A lock pin 78 extends through the aligned apertures 76 in the square shaped collar 58 and the transverse aperture 74 in the square shaped guide bar 56. A cotter pin 80 is releasably secured to the lock pin 78.

FIG. 7 is an enlarged diagrammatic side elevational view, partially in section, showing a second embodiment of the invention provisioned to accommodate for the installation on towing trucks of various heights, and as such, will be discussed with reference thereto.

The trailer hitch 110 is modified, in which the main support assembly 126 comprises a C-shaped member 142 having a top stop portion 144, a vertical elongated side portion 146 and a bottom stop portion 148. A plurality of sleeve members 182 are provided. The sleeve members 182 are spaced apart horizontally and mounted at their forward ends 184 to the vertical elongated side portion 146 of the C-shaped member 142. Each sleeve member 182 can be selectively removably connected by fasteners 186 to the rearward end 20 of the draw bar 36 of the hitch coupler 16 to accommodate for the installation on towing trucks 24 of various heights. A plurality of upper braces 150 are provided, wherein each upper brace 150 extends between two of the sleeve members 182. A lower brace 152 extends between the lowest sleeve member 182 and the bottom stop portion 148 of the C-shaped member 142. A base plate 154 is affixed to underside of the bottom stop portion 148 of the C-shaped members 142 and the lower brace 152. A vertical square shaped guide bar 156 is mounted between the top stop portion 144 and the bottom stop portion 148 and spaced away from the vertical elongated side portion 146 of the C-shaped member 142. The rest of the trailer hitch 110 is identical in construction with the trailer hitch 10 of the first embodiment.

It will be understood that each of the elements described above, or two or more together, may also find a useful application in other types of constructions differing from the types described above.

While the invention has been illustrated and described as embodiments of a trailer hitch for automatically allowing a trailer to tilt for facilitating driving a vehicle on and off the trailer, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A trailer hitch for automatically allowing a trailer to tilt for facilitating driving a vehicle on and off the trailer which comprises:
a) a hitch coupler having forward and rearward ends, the forward end of said hitch coupler adapted for removable connection to a receiver hitch of a towing truck;
b) a vertically oriented main support assembly connected to the rearward end of said hitch coupler;
c) a sliding mechanism carried on said main support assembly, wherein said sliding mechanism can freely travel between a lower position and an upper position on said main support assembly; and
d) a hitching mechanism attached to said sliding mechanism, said hitching mechanism suited for coupling the trailer to the towing truck, wherein when the vehicle is driven off the trailer onto a ramp of the trailer, the weight of the vehicle on the ramp will make wheels of the trailer act as a fulcrum, causing the trailer to tilt and said hitching mechanism to lift up said sliding mechanism from the lower position to the upper position on said main support assembly.

2. The trailer hitch as recited in claim 1, wherein said hitch coupler comprises:
a) a draw bar sized to fit into the receiver hitch;
b) a hitch pin for holding said draw bar within the receiver hitch; and
c) a cotter pin releasably secured to said hitch pin.

3. The trailer hitch as recited in claim 2, wherein said main support assembly comprises:
a) a C-shaped member having a top stop portion, a vertical elongated side portion and a bottom stop portion;
b) an upper brace extending between said draw bar of said hitch coupler and the top stop portion of said C-shaped member;
c) a lower brace extending between said draw bar of said hitch coupler and the bottom stop portion of said C-shaped member;
d) a base plate affixed to underside of the bottom stop portion of said C-shaped member and said lower brace; and
e) a vertical square shaped guide bar mounted between the top stop portion and the bottom stop portion and spaced away from the vertical elongated side portion of said C-shaped member.

4. The trailer hitch as recited in claim 3, wherein said sliding mechanism comprises a square shaped collar sized to freely slide on said vertical square shaped guide bar of said main support assembly.

5. The trailer hitch as recited in claim 4, wherein said hitching mechanism comprises:
a) a mounting plate connected to a forward side of said square shaped collar of said sliding mechanism;
b) a hitch bracket bolted onto said mounting plate; and
c) a hitch ball carried on a forward end of said hitch bracket which engages with a socket member on a towing end of the trailer.

6. The trailer hitch as recited in claim 5, wherein said hitching mechanism further comprises a retainer latch to help hold the socket member on the towing end of the trailer onto said hitch ball, if said retainer latch is flipped downwardly.

7. The trailer hitch as recited in claim 6, further comprising means for locking said square shaped collar to a lower end of said vertical square shaped guide bar to keep the trailer in a generally horizontal position when being towed by the towing truck.

8. The trailer hitch as recited in claim 7, wherein said locking means comprises:
a) said square shaped guide bar having an transverse aperture near the lower end;
b) said square shaped collar having a pair of aligned apertures with each aperture located on an opposite side thereof;
c) a lock pin to extend through the aligned apertures in said square shaped collar and the transverse aperture in said square shaped guide bar; and
d) a cotter pin releasably secured to said lock pin.

9. The trailer hitch as recited in claim 2, wherein said main support assembly comprises:
a) a C-shaped member having a top stop portion, a vertical elongated side portion and a bottom stop portion;
b) a plurality of sleeve members, wherein said sleeve members are spaced apart horizontally and mounted at their forward ends to said vertical elongated side portion of said C-shaped member, so that each said sleeve member can be selectively removably connected to the rearward end of said draw bar of said hitch coupler to accommodate for the installation on towing trucks of various heights;
c) a plurality of upper braces, wherein each said upper brace extends between two of said sleeve members;
d) a lower brace extending between said lowest sleeve member and the bottom stop portion of said C-shaped member;
e) a base plate affixed to underside of the bottom stop portion of said C-shaped member and said lower brace; and
f) a vertical square shaped guide bar mounted between the top stop portion and the bottom stop portion and spaced away from the vertical elongated side portion of said C-shaped member.

10. The trailer hitch as recited in claim 9, wherein said sliding mechanism comprises a square shaped collar sized to freely slide on said vertical square shaped guide bar of said main support assembly.

11. The trailer hitch as recited in claim 10, wherein said hitching mechanism comprises:
a) a mounting plate connected to a forward side of said square shaped collar of said sliding mechanism;
b) a hitch bracket bolted onto said mounting plate; and
c) a hitch ball carried on a forward end of said hitch bracket which engages with a socket member on a towing end of the trailer.

12. The trailer hitch as recited in claim 11, wherein said hitching mechanism further comprises a retainer latch to help hold the socket member on the towing end of the trailer onto said hitch ball, when said retainer latch is flipped downwardly.

13. The trailer hitch as recited in claim 12, further comprising means for locking said square shaped collar to a lower end of said vertical square shaped guide bar to keep the trailer in a generally horizontal position when being towed by the towing truck.

14. The trailer hitch as recited in claim 13, wherein said locking means comprises:
a) said square shaped guide bar having a transverse aperture near the lower end;
b) said square shaped collar having a pair of aligned apertures with each aperture located on an opposite side thereof;
c) a lock pin to extend through the alinged apertures in said square shaped collar and the transverse aperture in said square shaped guide bar; and
d) a cotter pin releasably secured to said lock pin.
